(19) United States
(12) Patent Application Publication
(10) Pub. No.: US 2002/0126313 A1
(43) Pub. Date: Sep. 12, 2002

(54) Image processing method and apparatus for varibly processing image based upon image characteristics

(76) Inventor: Yoshiyuki Namizuka, Kanagawa (JP)

Correspondence Address: KNOBLE & YOSHIDA, EIGHT PENN CENTER, SUITE 1350, 1628 JOHN F KENNEDY BLVD, PHILADELPHIA, PA, 19103, US

(21) Appl. No.: 10/078,713

(22) Filed: Feb. 19, 2002

(30) Foreign Application Priority Data
Feb. 21, 2001 (JP) 2001-045815

(51) Int. Cl. H04N 1/407; H04N 1/409; G06K 15/00; G06T 5/00

(52) U.S. Cl. 358/2.1; 382/274; 382/199; 358/3.27; 358/3.23; 382/266

(57) ABSTRACT

The image processing incorporates a regional difference such as an outline/edge area vs. a non-outline area in determining an appropriate correction coefficient. The image processing additionally includes any combination of an intensity level, a sharpness level and predetermined user input values. The input values include a user specified intensity level, a user specified document type, a user specified background removal level and other customized values.

### FIELD OF THE INVENTION

The current invention is generally related to image processing, and more particularly related to a storage medium containing computer instructions for processing an image to adjust an intensity level.

### BACKGROUND OF THE INVENTION

In conventional multifunctional, an image process has a plurality of intensity conversion methods and selects one of the intensity conversion methods based upon a type of original documents. In this regard, Japanese Patent Application Hei 9-224155 discloses an image processing apparatus which the above described technology. However, the above prior art technology take only the intensity characteristic into account for the intensity correction and fails to address any other image characteristics such as sharpness and regional differences. The regional differences are based upon the characteristics of the relative location in the image. For example, for image intensity, an outline portion of the image that outlines an image should be differently processed from a non-outline portion of the image that is included in the outline portion. Furthermore, sharpness of the image should be also taken into account. A combination of the above additional factors should be balanced in order to reproduce a high-quality image.

To produce a high-quality image, it is desirable to optimize image data based upon a combination of the gradation, the intensity and the sharpness at a reasonably low cost.

### SUMMARY OF THE INVENTION

In order to solve the above and other problems, according to a first aspect of the current invention, a method of processing image data, including the steps of: inputting image data; determining whether or not a portion of the image data is an outline portion to generate an outline characteristic; selecting a correction coefficient from a set of predetermined correction coefficients based upon the outline characteristic; and applying the selected correction coefficient to the portion of the image data.

According to a second aspect of the current invention, a system for processing image data, including: an image data input unit for inputting image data; a space filter process unit connected to the image data input unit for determining at least whether or not a portion of the image data is an outline portion to generate an outline characteristic; and

an intensity correction unit connected to the space filter process unit for selecting a correction coefficient from a set of predetermined correction coefficients based upon the outline characteristic and applying the selected correction coefficient to the portion of the image data.

According to a third aspect of the current invention, a storage medium for storing compute readable instructions for processing image data, the computer instructions performing the steps of: inputting user input values; determining whether or not a portion of image data is an outline portion to generate an outline characteristic; selecting a correction coefficient from a set of predetermined correction coefficients based upon the outline characteristic and the user input values; and applying the selected correction coefficient to the portion of the image data.

These and various other advantages and features of novelty which characterize the invention are pointed out with particularity in the claims annexed hereto and forming a part hereof. However, for a better understanding of the invention, its advantages, and the objects obtained by its use, reference should be made to the drawings which form a further part hereof, and to the accompanying descriptive matter, in which there is illustrated and described a preferred embodiment of the invention.

### BRIEF DESCRIPTION OF THE DRAWINGS

FIG. 1 is a block diagram illustrating a preferred embodiment of the image processing apparatus according to the current invention.

FIG. 2 is a block diagram further illustrating some more detailed units in a preferred embodiment of the image processing apparatus according to the current invention.

FIG. 3 is a diagram illustrating one preferred embodiment of a sharpness adjustment unit according to the current invention.

FIG. 4 is a diagram illustrating a selection criterion for the MTF correction process according to the current invention.

FIG. 5 is a diagram illustrating the intensity adjustment process according to the current invention.

FIG. 6A is a graph illustrating conversion characteristic curves that are applicable to non-outline portions.

FIG. 6B is a graph illustrating conversion characteristic curves that are applicable to outline portions.

FIG. 7 is a diagram illustrating one preferred embodiment of the edge detection unit according to the current invention.

FIG. 8 is a pair of tables shows a combination of processes to be performed based upon the image mode from the operation unit according to the current invention.

FIG. 9A is a diagram that illustrates a preferred embodiment of the operation control according to the current invention.

FIG. 9B is a diagram for illustrating the control unit which has been set to an exemplary initialize selection.

FIG. 10 is a flow chart illustrating steps involved in a preferred process of image processing according to the current invention.

### DETAILED DESCRIPTION OF THE PREFERRED EMBODIMENT(S)

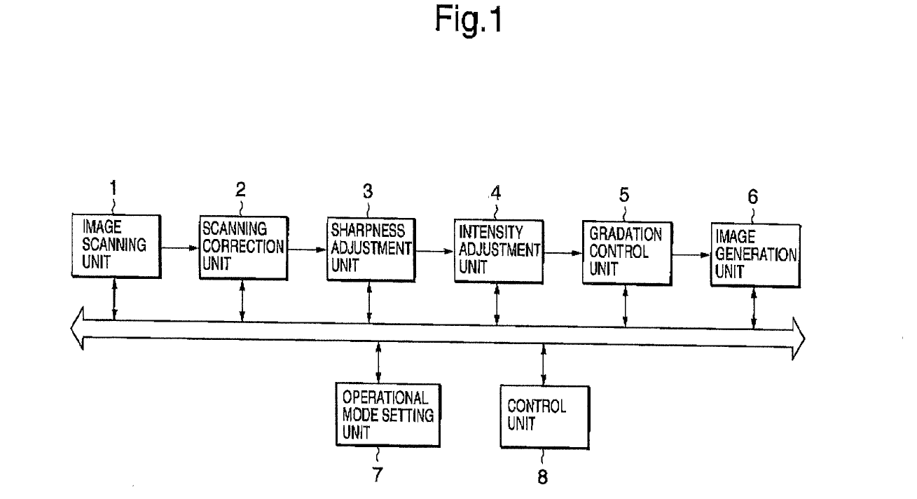

Referring now to the drawings, wherein like reference numerals designate corresponding structures throughout the views, and referring in particular to FIG. 1, a block diagram illustrates a preferred embodiment of the image processing apparatus according to the current invention. The image processing apparatus 10 includes an image scanning unit 1, a scanning correction unit 2, a sharpness adjustment unit 3, an intensity adjustment unit 4, a gradation control unit 5, an image generation unit 6, an operational mode setting unit 7 and a control unit 8. In general, the image scanning unit 1 further includes an image reduction optical component, a contact sensor and a color or monochromatic scanner. The image information that has been scanned by the image scanning unit 1 is converted into electrical signals. The scanning correction unit 2 corrects scanning error or distortion in the converted electrical signals of the scanned image. For example, a fluctuation in light from a lamp is corrected. The sharpness adjustment unit 3 performs signal correction for generating a sharp or soft finish in an output image. The intensity adjustment unit 4 performs contrast adjustment on the original image to generate a weak or dark image. The gradation control unit 5 processes the intensity level of the scanned image to print an image on paper in gradation. The image generation unit 6 is either an electrostatic photo processing unit or an ink jet printer in color or black and white. The operational mode setting unit 7 allows a user to specify an image reproduction mode and other adjustment options. Based upon the specified image reproduction mode and the adjustment options, the control unit 8 controls the corresponding function blocks.

In another preferred embodiment, the above described image processing functions are implemented in a recording medium containing computer readable instructions for performing the steps of image processing according to the current invention.

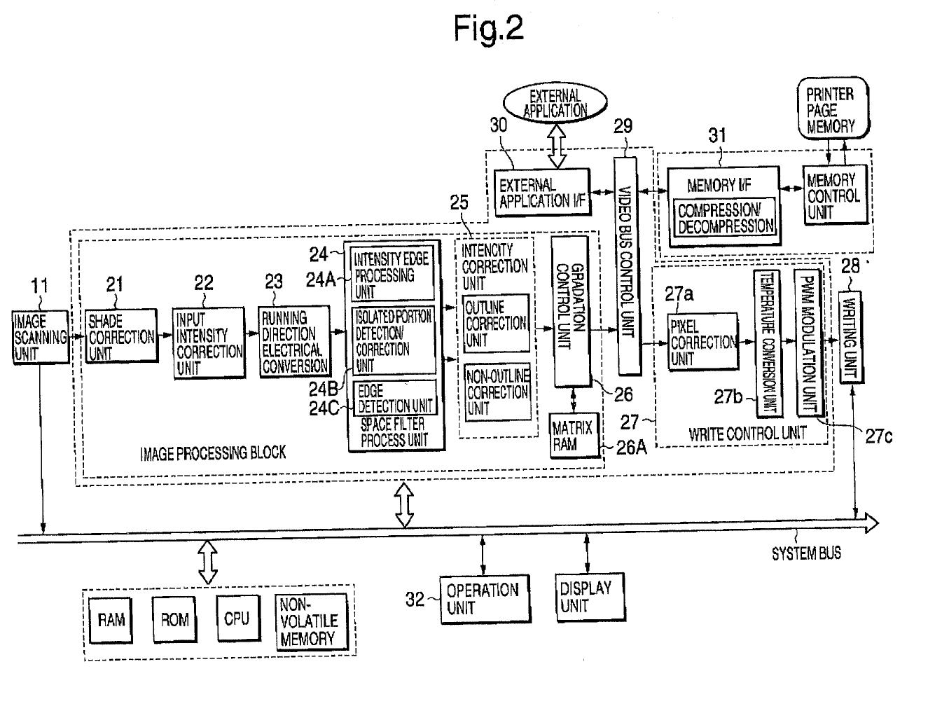

Now referring to FIG. 2, a block diagram further illustrates some more detailed units in a preferred embodiment of the image processing apparatus according to the current invention. An image scanning unit 11 optically scans an image intensity level by reading light reflected off from an original image. The image scanning unit 11 further includes image pixel elements such as CCDs to convert the scanned light into electrical signals and converts the analog electrical signal to digital signals. After the signals are converted to electrical signals, a shade correction unit 21 performs a correction process on the digital data to correct non-uniformity in intensity due to a light source and or an optical system. Prior to scanning an image documents, a white board of a predetermined intensity standard has been scanned, and the corresponding scanned data has been stored in memory. For each scanned position in a running direction, the scanned data is corrected based upon the above standard data.

Still referring to FIG. 2, after the above shading correction, the digital signal has become linear with respect to the reflection rate. An input intensity correction unit or scanner γ correction unit 22 process the digital signal to make it also linear with respect to the original intensity level in the document. The scanner characteristic is previously measured, and an inverse conversion table is generated for compensating for the measured characteristics to correct the scanned image data. The inverse conversion table is read into RAM from a storage unit prior to use. The input intensity correction unit or scanner γ correction unit 22 makes the digital data liner with respect to the intensity level based upon the inverse conversion table. The above conversion not only increases low intensity areas, but also decreases high intensity areas in order to maximize the correction effects. A running direction electrical conversion unit 23 enlarges or reduces an image based upon one line of data as a unit that is read by the CCD. By using a convolution method, the size change process is performed while the MTF of the optical component of the scanning unit is kept. The resolution of the image data is maintained. In a sub-running direction, the size change is performed by a mechanical control. A space filter process unit 24 extracts characteristic values and preprocesses for the subsequent gradation process. In general, the space filter process unit 24 includes the following major functions such as MTF correction, a smoothing process 24a and edge detection 24c and setting a threshold values for intensity changes 24b. The output from the space filter process unit 24 includes the filtered image data and the edge information for outline or contour portions of the image. As necessary, an intensity correction unit 25 corrects the intensity level of the image data based upon the above edge information. The intensity correction unit 25 generally corrects the intensity in the scanned intensity for regenerating the image based upon the standard intensity. As described above, the intensity correction unit 25 utilizes a previously stored conversion data from RAM. For an outline intensity correction unit 25a and a non-outline intensity correction unit 25b, a desired set of conversion data is separately downloaded from the RAM.

A gradation unit 26 converts the intensity data of one pixel into area gradation data according to an outputting characteristic. The conversion includes simple multiple values, binarization, dithering, error diffusion and phase control. To convert to the area degradation data, quantization thresholds are distributed in a predetermined area. To distribute the thresholds, predetermined values are downloaded into a matrix RAM 26A, and a desired quantization set is used based from the matrix RAM 26A upon a processing mode. A pixel correction unit 27a in a write control block 27 smoothes over edges in the image data. Prior to modulation, an intensity conversion process for onset characteristics is performed on electrical signals for forming an image to increase the reproduction fidelity of dots. In a PWM modulation unit 27c performs pulse width sub modulation for a writing laser. The pulse width modulation is coordinated with the phase control in the gradation control unit 26 in order to realize the smooth transitions between concentrated dots and distributed dots. Finally, a writing unit 28 forms an image on a photo receptor drum via laser, transfers the image onto an image recording medium and fixes the transferred image in order to reproduce the original image. In the above described preferred embodiment, the writing unit 28 is implemented as a laser printer. In an alternative embodiment with a writing unit such as an ink jet, although the smoothing for reproducing dots and the intensity conversion control are common with the preferred embodiment, a development method requires that the PWM modulation unit 27c be different.

Still referring to FIG. 2, the preferred embodiment of the image processing apparatus according to the current invention also includes other units. An operation unit 32 allows a user or an external unit to specify an operation mode or a processing mode as well as operation or intensity correction parameters. Based upon the specified operation mode, the selection is made in the setting of the gradation process, the scanner gamma correction process, the intensity correction of the scanned image data and the writing intensity control. The processing mode is selected based upon a type of a document, and the type is determined based upon an amount of text or picture. The intensity correction parameters are also set based upon the intensity level of the original document. In the preferred embodiment, in response to the operation mode from the operation unit 32, the system control is implemented by storing the operation mode value and the correction parameter values in RAM via CPU and setting a processing path in a corresponding unit via a system bus. In each image signal, although the bus control is physically in one unit, the control is logically divided into smaller units.

A first function of a video bus control unit 29 is to control the signals indicative of a scanned image. When the signal is 8-bit after the A/D conversion via the CCD, the bus control is performed with the same bit width. Through the bus control, an external application interface 30 controls an external application such as a scanner application program. Via a memory interface unit 31, data is stored in or read from a scanner buffer memory. A second function of the video bus control unit 29 is to control a data bus after the image data has been processed. During the image processing, the bid width is converted to either binary or a plurality of multi values. To accommodate the bit width of the data bus, the process controls the data. Although the video bus control unit 29 controls input and output signals from an external application via the external application interface unit 30, output signals such as a fax transmission and a print out from a personal computer are implemented with binary image data. Via the memory interface unit 31, data is stored in or read from a printer buffer memory. The data is transmitted according to a number of bits in the writing unit.

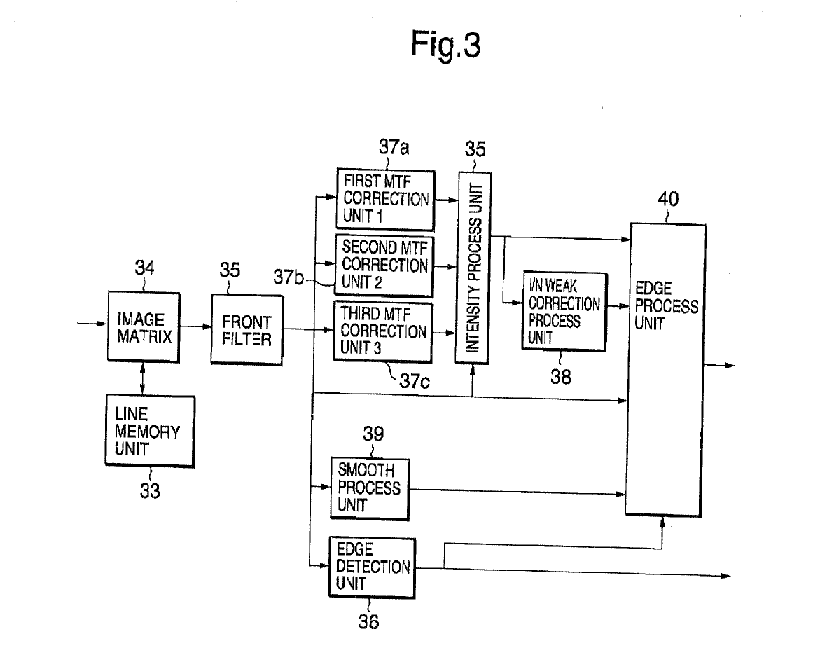

Now referring to FIG. 3, a diagram illustrates one preferred embodiment of a sharpness adjustment unit according to the current invention. In general, the image data is processed based upon the information on edges and intensity from a space filter process unit. After the scanned image data is corrected, the corrected image data is grouped into a plurality of lines of data in a line memory unit 33 to form an image matrix 34 for accessing the image data on a two-dimensional basis. A front filter 35 filters the image matrix data to primarily remove aliasing distortions due to the A/D conversion and unnecessary frequency bands. After the above distortions are removed from a wide range of the signal frequencies, an edge detection unit 36 performs an edge detection process on the image data. A set of a first MTF correction unit 37a, a second MTF correction unit 37b and a third MTF correction unit 37c also performs a main filter process on the image data. To distinguish outline or edge portions of the image data from non-outline or non-edge portions of the image data, an edge detection unit 36 detects valid edges within the image. Since the front filter 35 has removed noise, a majority of the detected edges is valid. However, only outlines are selected from the detected edges.

The above main filter process includes an emphasis filter group for the MTF correction, an original data pass filter after the front filter process and a smoothing filter. The original data pass filter is also used for determining intensity information on unprocessed pixels. The emphasis filter applies a plurality of filter coefficient to the same image in parallel. To select one of the processed results, the intensity information is used to define a strong emphasis result. Using the emphasis filter result, a 1/N weak correction unit 38 applies a 1/Nth correction amount to generate a weak emphasis result. A smooth process unit 39 further filters out a wide range of the input data to generate smoothly transitioned pixel positions by effectively eliminating the noise. Among the strong emphasis result, the weak emphasis result and the smoothed result, an edge processing unit 40 applies an appropriate process based upon an edge signal that is indicative of an outline portion. Based upon the edge signal and the image reproduction mode from the operational unit, the selection pass is switched.

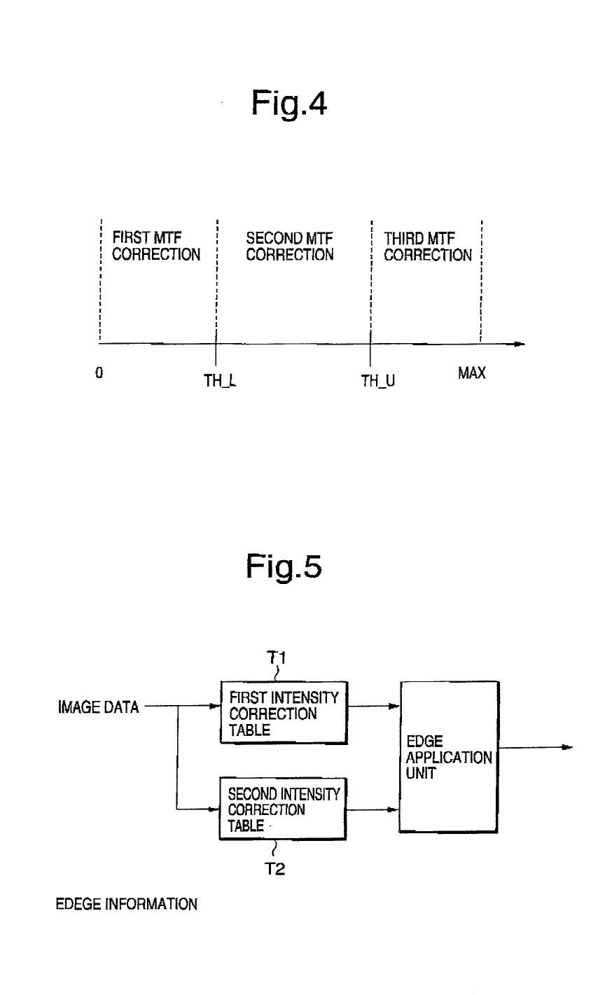

Now referring to FIG. 4, a diagram illustrates a selection criterion for the MTF correction process according to the current invention. The emphasis filter group unit receives the front filter result as an input from the front filter 35. Based upon the threshold value in the input data, the output selection value is determined. In the preferred embodiment, there are two predetermined threshold values for the intensity, and these threshold values include a first threshold value TH_L and a second threshold value T_U. When the input intensity of a current pixel is within a range from 0 to the first threshold value TH_L during the emphasis process, the first MTF correction process is selected. Similarly, when the input intensity of a current pixel is within a range from the first threshold value TH_L to a second threshold value TH_U during the emphasis process, the second MTF correction process is selected. Lastly, when the input intensity of a current pixel is within a range from the second threshold value TH_U to a maximal value MAX during the emphasis process, the third MTF correction process is selected. The MTF process is selected based upon the relation between the importance of the information and the intensity level. That is, low intensity areas that are smudges are not emphasized while low intensity areas that are text or characters are emphasized. Originally high intensity areas are not emphasized since there is a sufficient difference in intensity between the high intensity areas and the surrounding areas. The above described predetermined threshold values TH_L and TH_U determine which areas are emphasized and how much emphasis is made, and the two threshold values TH_L and TH_U are arbitrary determined.

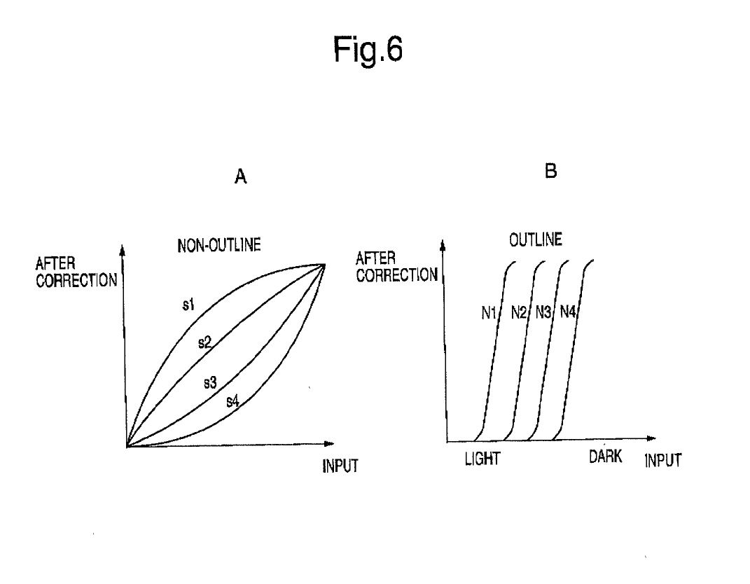

Now referring to FIG. 5, a diagram illustrates the intensity adjustment process according to the current invention. Based upon the edge information, one of two intensity correction tables T1 and T2 is selected. The edge information includes the intensity notch that is inputted via the operation unit. The intensity correction tables T1 and T2 respectively contain the intensity conversion characteristic data for the outline portions and the non-outline portions. The first intensity correction table T1 is used to regenerate sharp transitions in intensity for outline portions. On the other hand, the second intensity correction table T2 is used to regenerate smooth transitions in intensity for non-outline portions. In summary, the intensity correction is performed on the image data that has been processed based upon the edge information from the above described sharpness adjustment process. As described above, the intensity correction for the sharp transition is performed on the outline portions while that for the smooth transition is performed on the non-outline portions.

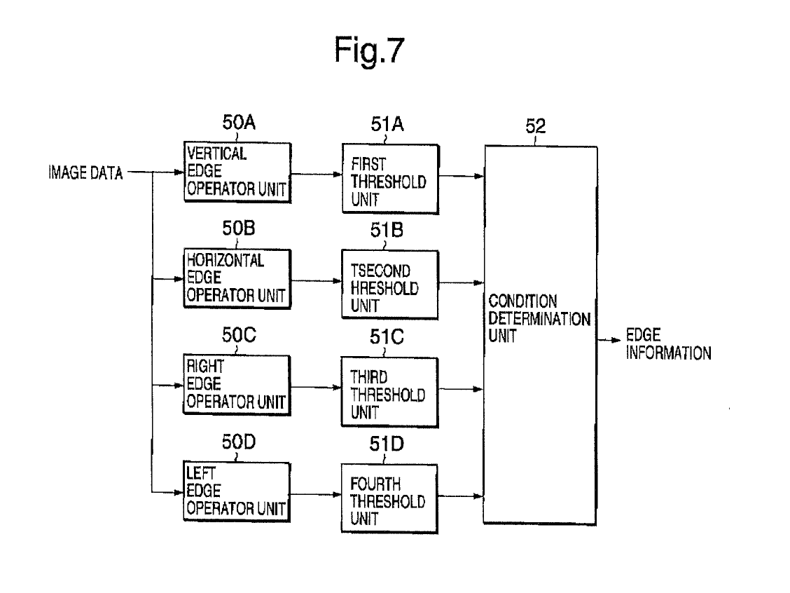

FIGS. 6 is a pair of graphs that illustrate an example of conversion characteristic according to the current invention. In general, for a non-outline portion, the conversion characteristic has a mild incline and includes a full input range of intensity changes. On the other hand, for an outline portion, the conversion characteristic has a sharp incline to generate sharp lines. Referring particularly to FIG. 6A, conversion characteristic curves S1, S2, S3 and S4 are applicable to non-outline portions, and one of the characteristic curves S1, S2, S3 and S4 is selected based upon a selection level of the intensity notch. Similarly, referring particularly to FIG. 6B, conversion characteristic curves N1, N2, N3 and N4 are applicable to outline portions, and one of the characteristic curves N1, N2, N3 and N4 is selected based upon a selection level of the intensity notch.

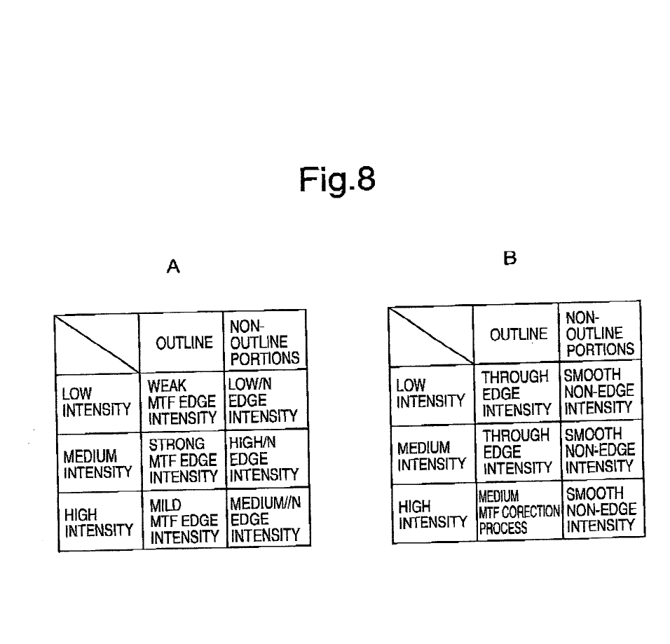

Now referring to FIG. 7, a diagram illustrates one preferred embodiment of the edge detection unit according to the current invention. In general, based upon the two dimensional position, edge portions are detected from the image data after being processed by the front filter. A different edge portion is found by a corresponding unit based upon an edge operator. An example is a Laplacean. A vertical edge operation unit 50A detects vertical edges while a horizontal edge operation unit 50B detects horizontal edges. By the same token, a right edge operation unit 50C detects right edges while a left edge operation unit 50D detects left edges. After the above detection, the detection is verified by a use of a threshold value and a predetermined condition. Finally, the edge information is outputted. The threshold units 51A through 51D respectively determine as to whether or not a detected edge is dark enough based upon a comparison to the predetermined threshold value. If the intensity of the detected edge is below the predetermined threshold value, the detected edge is determined to be invalid. The predetermined threshold value is independently provided for each direction or orientation of the detected edges. The first threshold unit 51A compares the detected vertical edge to a predetermined threshold value TH1. Similarly, the second threshold unit 51B compares the detected horizontal edge to a predetermined threshold value TH2. The third and fourth threshold units 51C and 51D respectively compare the detected right and left edges to predetermined threshold values TH3 and Th4. Finally, the condition determination unit 52 confirms as to whether or not the detected edges meet a predetermined set of remaining conditions. For example, the remaining conditions include connecting lines rather than discontinuing lines and the continuing line is situated in a substantially single direction.

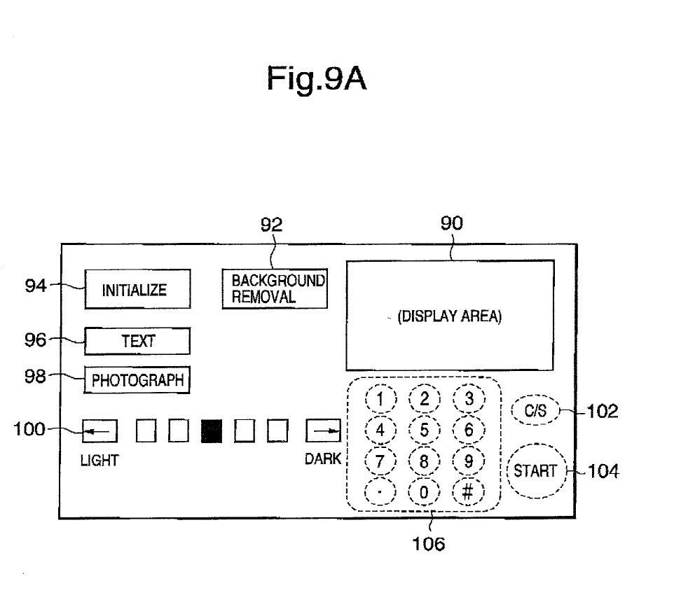

Referring to FIG. 8, a pair of tables shows a combination of processes to be performed based upon the image mode from the operation unit according to the current invention. The sharpness adjustment is made whether an image portion is an edge or a non-edge portion. The intensity adjustment is made whether an image mode is low intensity, medium intensity or high intensity. FIG. 8A is an exemplary character mode in which sharp lines are prioritized to reproduce while mild gradation is maintained. The outline portions are processed by the MTF correction, and the non-outline portions are mildly processed by the 1/Nth correction. Furthermore, within the outline portion, medium intensity portions such as a pencil line should be processed by a strong MTF correction process while low intensity portions such as a smudge in the background should be processed by a weak MTF correction process. Lastly, the high intensity portions are processed by a mild MTF correction process in order to maintain a uniform intensity level.

FIG. 8B is an exemplary photo mode in which gradation is prioritized while blurred outlines are corrected. Only dark line portions of the outlines are corrected. Other line portions are smoothly graduated or the original image data is used. The non-outline portions are uniformly smoothed. The low intensity areas and the medium intensity area of the outline portions are used through edge intensity data without any MTF correction process or smoothing process. Only the high intensity areas of the outline portions are processed by the medium MTF correction process. Although the front filter has removed a substantial amount of aliasing noise, since there is some residual noise, no significantly intense correction is applied to avoid the amplified noise.

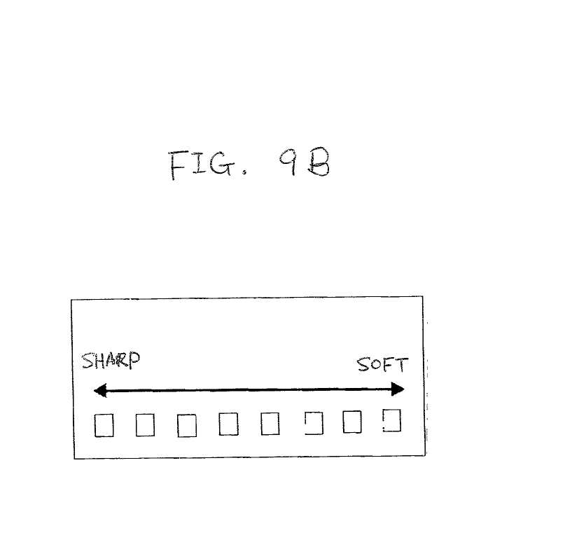

Now referring to FIGS. 9A and 9B, a diagram illustrates a preferred embodiment of the operation unit according to the current invention. The diagram further illustrates one example of initialization. In general, the input instructions through the operation unit control corresponding functions via a control processor. Referring to FIG. 9A, the operation control includes a display area 90, a background removal button 92, an initialize button 94, a text button 96, a photograph button 98, an intensity control slide or notch buttons 100, a clear/stop (C/S) button 102, a start button 104 and numerical key bad 106. The above described buttons are implemented on a touch-sensitive display monitor or mechanical buttons. The background removal button 92 specifies a background removal level from a predetermined set of levels which includes a complete removal of the background and some removal of the background. The background removal button 92 sets a threshold vale for the corresponding level of removal. The text button 96 and photograph button 98 correspondingly set an image processing mode for image data for the above described sharpness as well as intensity adjustments. The initialize button 94 allows the customization of the sharpness and intensity adjustments to have minor adjustments. For example, the default text mode is adjusted to a little sharper or a little softer. The intensity control slide or notch buttons 100 sets an appropriate intensity process based upon the outline characteristic in the corresponding conversion table. FIG. 9B illustrates a diagram for the control unit which has been set to an exemplary initialize selection. Based upon the sharpness-softness setting, the MTF correction efficient, the intensity threshold value, the edge detection threshold value and the intensity conversion table content are all grouped and adjusted. The above described parameters and threshold values are stored in non-volatile memory and are repeatedly used.

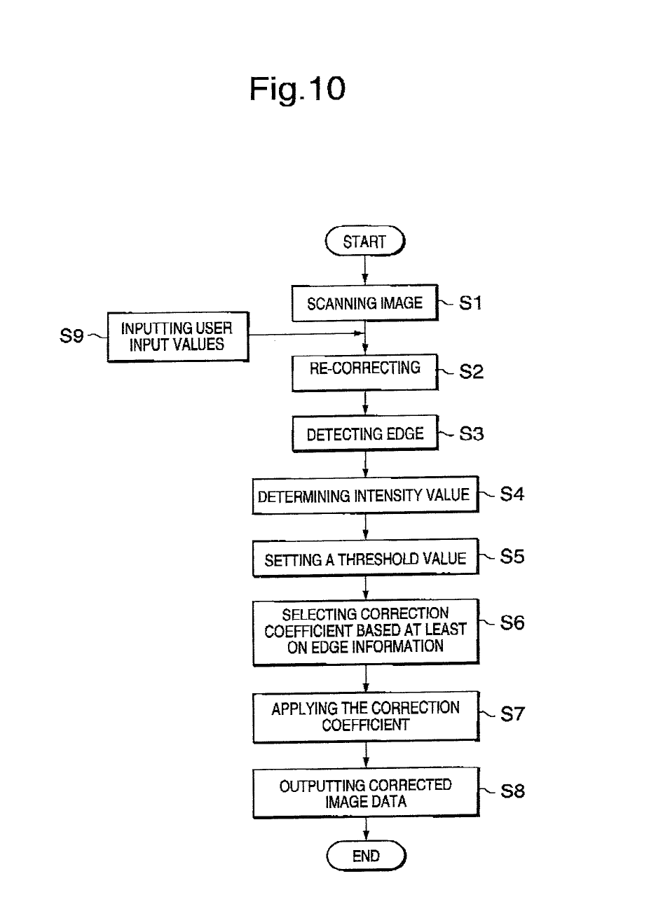

FIG. 10 is a flow chart illustrating steps involved in a preferred process of image processing according to the current invention. In a step S1, a document is scanned by a scanner, and scanned image data is generated. After the scanned image data generation, a user optionally inputs user input values via a control unit in a step S9. The user input values include custom data, a type value of documents such as text or picture, an intensity notch or scale value and a background removal value. In a step S2, the scanned image data is initially corrected for distortions and errors that have been caused by the optical and mechanical means in the scanner. The pre-corrected image data from the step S2 is now processed to detect edges or outline portions in a step S3. In general, the outline portions include specific edges that specify the boundaries of the outline portions. The edge detection in the step S3 generates edge information. The edge information includes the location of the edges, the outline portion as well as a direction of the edges such as vertical, horizontal, right and left. In addition, the pre-corrected image data from the step S2 is also processed to determine the intensity level of a certain area of the image in a step S4. Based upon the above determined intensity levels, a set of threshold values are established for correcting the intensity of the image data in a step S5.

Still referring to FIG. 10, the following steps of the preferred steps are performed to optimally correct the intensity level of the image data according to the current invention. Based upon at least the above determined edge information, an optimal correction coefficient is selected from a set of predetermined correction coefficients in a step S6. Optionally, the optimal correction coefficient is selected based upon a combination of the edge information, the intensity information and a variety of the user input values. Furthermore, a plurality of sets of coefficients includes intensity coefficients and sharpness coefficients for adjusting the image data, and the optimal correction coefficient is selected for the intensity adjustment and for the sharpness adjustment. The selected coefficient is applied to the image data to perform the intended correction in a step S7. Finally, the corrected image data is outputted to reproduce an intended image in a step S8. The above described steps are repeated for a predetermined unit of the image data.

It is to be understood, however, that even though numerous characteristics and advantages of the present invention have been set forth in the foregoing description, together with details of the structure and function of the invention, the disclosure is illustrative only, and that although changes may be made in detail, especially in matters of shape, size and arrangement of parts, as well as implementation in software, hardware, or a combination of both, the changes are within the principles of the invention to the full extent indicated by the broad general meaning of the terms in which the appended claims are expressed.

What is claimed is:

1. A method of processing image data, comprising the steps of:
inputting image data;
determining whether or not a portion of the image data is an outline portion to generate an outline characteristic;
selecting a correction coefficient from a set of predetermined correction coefficients based upon said outline characteristic; and
applying the selected correction coefficient to the portion of the image data.

2. The method of processing image data according to claim 1 wherein the image data is scanned.

3. The method of processing image data according to claim 2 further comprising an additional step of correcting the scanned image data prior to said applying step.

4. The method of processing image data according to claim 1 wherein said correction coefficients include intensity correction coefficients.

5. The method of processing image data according to claim 1 wherein said correction coefficients include sharpness correction coefficients.

6. The method of processing image data according to claim 1 further comprising additional steps of:
inputting user input values prior to said selecting step; and
selecting said correction coefficient from said set of said predetermined correction coefficients based upon said outline characteristic and a combination of said user input values.

7. The method of processing image data according to claim 6 wherein said user input values include an intensity notch signal.

8. The method of processing image data according to claim 6 wherein said user input values include an image type signal.

9. The method of processing image data according to claim 6 wherein said user input values include customize data.

10. The method of processing image data according to claim 6 wherein said user input values include a background removal signal.

11. The method of processing image data according to claim 1 further comprising additional steps of:
further determining an image intensity level of the portion of the image data prior to said applying step; and
selecting said correction coefficient from said set of said predetermined correction coefficients based upon said outline characteristic and said image intensity level.

12. The method of processing image data according to claim 11 wherein said predetermined correction coefficients are previously stored in a table.

13. The method of processing image data according to claim 1 wherein said determining step further determines whether or not said outline portion has a particular direction.

14. The method of processing image data according to claim 13 wherein said particular direction includes a right edge, a left edge, a horizontal edge and a vertical edge, corresponding edge information being generated.

15. A system for processing image data, comprising:
an image data input unit for inputting image data;
a space filter process unit connected to said image data in put unit for determining at least whether or not a portion of the image data is an outline portion to generate an outline characteristic; and
an intensity correction unit connected to said space filter process unit for selecting a correction coefficient from a set of predetermined correction coefficients based upon the outline characteristic and applying the selected correction coefficient to the portion of the image data.

16. The system for processing image data according to claim 15 wherein the image data input unit is an image scanner.

17. The system for processing image data according to claim 16 further comprising a pre-correction unit connected to said scanner and said space filter process unit for correcting the scanned image data to generate preprocessed image data prior to outputting the preprocessed image data to said space filter process unit.

18. The system for processing image data according to claim 15 wherein the correction coefficients include intensity correction coefficients.

19. The system for processing image data according to claim 15 wherein the correction coefficients include sharpness correction coefficients.

20. The system for processing image data according to claim 15 further comprises an operation unit connected to said space filter process unit for inputting user input values, wherein said space filter process unit selects the correction coefficient from said set of the predetermined correction coefficients based upon the outline characteristic and a combination of the user input values.

21. The system for processing image data according to claim 20 wherein the user input values include an intensity notch signal.

22. The system for processing image data according to claim 20 wherein the user input values include an image type signal.

23. The system for processing image data according to claim 20 wherein the user input values include customize data.

24. The system for processing image data according to claim 20 wherein the user input values include a background removal signal.

25. The system for processing image data according to claim 15 wherein said space filter process unit further determines an image intensity level of the portion of the image data prior to applying the selected correction coefficient and selects the correction coefficient from the set of the predetermined correction coefficients based upon the outline characteristic and the image intensity level.

26. The system for processing image data according to claim 25 further comprises a storage unit connected to said intensity correction unit for storing the predetermined correction coefficients in a table format.

27. The system for processing image data according to claim 15 wherein said space filter process unit further determines whether or not the outline portion has a particular direction.

28. The system for processing image data according to claim 27 wherein the particular direction includes a right edge, a left edge, a horizontal edge and a vertical edge, said space filter process unit generating corresponding edge information.

29. A storage medium for storing compute readable instructions for processing image data, the computer instructions performing the steps of:
inputting user input values;
determining whether or not a portion of image data is an outline portion to generate an outline characteristic;
selecting a correction coefficient from a set of predetermined correction coefficients based upon the outline characteristic and the user input values; and
applying the selected correction coefficient to the portion of the image data.

30. The storage medium for storing compute readable instructions according to claim 29 wherein the image data is scanned.

31. The storage medium for storing compute readable instructions according to claim 30 further comprising an additional step of correcting the scanned image data prior to said applying step.

32. The storage medium for storing compute readable instructions according to claim 29 wherein said correction coefficients include intensity correction coefficients.

33. The storage medium for storing compute readable instructions according to claim 29 wherein said correction coefficients include sharpness correction coefficients.

34. The storage medium for storing compute readable instructions according to claim 29 wherein said user input values include an intensity notch signal.

35. The storage medium for storing compute readable instructions according to claim 29 wherein said user input values include an image type signal.

36. The storage medium for storing compute readable instructions according to claim 29 wherein said user input values include customize data.

37. The storage medium for storing compute readable instructions according to claim 29 wherein said user input values include a background removal signal.

38. The storage medium for storing compute readable instructions according to claim 29 further comprising additional instructions for performing the steps:
further determining an image intensity level of the portion of the image data prior to said applying step; and
selecting said correction coefficient from said set of said predetermined correction coefficients based upon said outline characteristic and said image intensity level.

40. The storage medium for storing compute readable instructions according to claim 29 wherein said predetermined correction coefficients are previously stored in a table.

41. The storage medium for storing compute readable instructions according to claim 29 wherein said determining step further determines whether or not said outline portion has a particular direction.

42. The storage medium for storing compute readable instructions according to claim 41 wherein said particular direction includes a right edge, a left edge, a horizontal edge and a vertical edge, corresponding edge information being generated.
